(19) United States
(12) Patent Application Publication
(10) Pub. No.: US 2026/0319527 A1
(43) Pub. Date: Oct. 15, 2026

(54) TRANSPORTATION MANAGEMENT DEVICE, TRANSPORTATION MANAGEMENT METHOD, AND TRANSPORTATION MANAGEMENT SYSTEM

(71) Applicant: HITACHI, LTD., Tokyo (JP)

(72) Inventors: Taku SHIMIZU, Tokyo (JP); Kazuki MATSUO, Tokyo (JP)

(21) Appl. No.: 19/491,556

(22) PCT Filed: May 13, 2024
(86) PCT No.: PCT/JP2024/017691

§ 371 Date: Dec. 9, 2025

(30) Foreign Application Priority Data
Jun. 14, 2023 (JP) 2023-097956

(51) Int. Cl. G05D 1/698; B64U 10/13; B64U 101/64; G05D 1/65; G05D 105/28; G05D 109/20; G08G 5/34; G08G 5/57; G08G 5/72; G08G 5/76

(52) U.S. Cl. CPC G05D 1/6987; B64U 10/13; G05D 1/651; G08G 5/34; G08G 5/57; G08G 5/72; G08G 5/76; B64U 2101/64; G05D 2105/28; G05D 2109/20

(57) ABSTRACT

The computer is capable of accessing a storage device that stores the positions of a plurality of cargo handling points for the transportation machines to load and unload the transportation objects. On the basis of an inputted shipping point, an inputted shipping time, and an inputted destination of luggage, the computer selects a machine in charge that is at least one transportation machine in charge of transportation of the luggage in accordance with the current positions of the plurality of transportation machines, selects a cargo handling point at which the machine in charge performs loading and unloading of the luggage, computes the time at which the machine in charge arrives at the cargo handling point and leaves the cargo handling point, creates the movement plan, and controls the machine in charge on the basis of the movement plan.

### TECHNICAL FIELD

The present invention relates to a transportation management device, a transportation management method, and a transportation management system.

### BACKGROUND ART

For the sake of reduction of the cost of transportation operations, shortening of transportation time periods, and the like, there have been suggested transportation systems utilizing unmanned transportation machines, such as drones. As systems of this type, in view of improvement of convenience, and in view of overcoming the problem of difficulty of delivery to houses and the like through only drones due to limitation of landing spots, there has been suggested combining plural transportation machines such as drones and trucks, for example, rather than using only single transportation machine.

For example, Patent Literature 1 discloses a system adapted to guide an unmanned aircraft carrying a cargo to cause it to land on a vehicle being driven by a person to receive the cargo and to deliver the cargo through cooperation between the unmanned aircraft and the vehicle.

Further, Patent Literature 2 discloses a system constituted by an unmanned aircraft and a vehicle in charge of delivery in a certain area, in which when the unmanned aircraft carrying a cargo has approached a cargo-delivery area, a transfer spot is instructed, based on the position of the vehicle in charge of delivery in this area.

### CITATION LIST

### Patent Literature

### Patent Literature 1: Japanese Unexamined Patent Application Publication No. 2022-66043

### Patent Literature 2: Japanese Patent No. 6775091

### SUMMARY OF INVENTION

### Technical Problem

In the techniques described in Patent Literatures 1 and 2, the cargo is directly transferred from the unmanned aircraft to the vehicle. However, in comparison between an unmanned aircraft and a vehicle, generally, the vehicle can singly transport the cargos with a larger weight and a larger amount number of cargos. Therefore, in some cases, it is effective to temporarily store the cargos transported by plural unmanned aircrafts at a loading spot, and collectively transport these plural cargos by a single vehicle. In this case, it is impossible to optimize the running efficiency of each transportation machine, only by merely guiding the unmanned aircraft and the vehicle to the cargo storage area.

The present invention was made in view of the above and aims at providing a transportation management device, a transportation management method and a transportation management system capable of improving a running efficiency of an entire transportation system including unmanned transportation machines.

### Solution to Problem

In order to solve the above problem, according to an aspect of the present invention, there is provided a transportation management device for managing transportation of a to-be-transported object, the transportation management device including a computer for creating a movement plan for a plurality of transportation machines including at least one unmanned transportation machine. The computer can access a storage storing positions of a plurality of loading spots at which the transportation machines load and unload the to-be-transported object thereon and therefrom. The computer selects a machine in charge as at least one transportation machine in charge of transportation of a cargo, and, further, selects a loading spot at which the machine in charge is to load or unload the cargo thereon or therefrom, according to current positions of the plurality of transportation machines, based on a dispatch spot, a dispatch time, and a destination for the cargo, which have been inputted. The computer calculates times when the machine in charge is to arrive at and depart from the loading spot and creates the movement plan.

### Advantageous Effects of Invention

According to the present invention, a running efficiency of an entire transportation system including unmanned transportation machines can be improved.

### BRIEF DESCRIPTION OF DRAWINGS

FIG. 1 is a view schematically illustrating a general structure of a transportation management device according to an embodiment of the present invention.

FIG. 2 is an image diagram of a movement plan transmitted to a manned transportation machine in the transportation management device according to an embodiment of the present invention.

FIG. 3 is a flow chart illustrating a procedure of creating and outputting a movement plan in the transportation management device according to an embodiment of the present invention.

FIG. 4 is an image diagram of creation of a movement plan.

### DESCRIPTION OF EMBODIMENTS

Embodiments related to this invention will be described below with reference to the drawings.

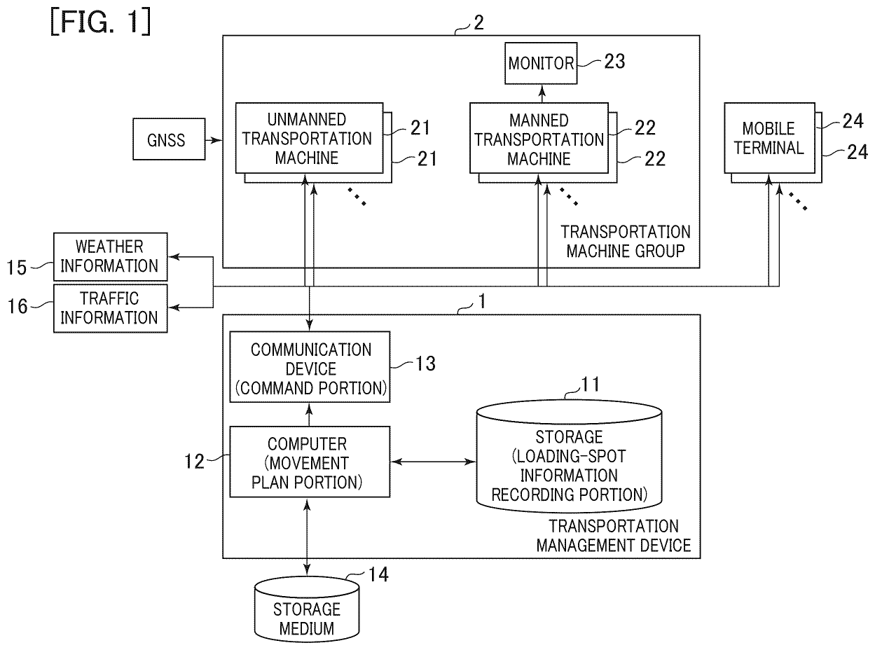

FIG. 1 is a schematic view illustrating a general structure of a transportation management device according to an embodiment of the present invention. The transportation management device 1 illustrated in FIG. 1 is a device that includes a computer for creating a movement plan as control information about a transportation machine group 2 and manages transportation of to-be-transported objects.

### The Transportation Machine Group

The transportation machine group 2 comprehensively refers to a plurality of transportation machines constituting a transportation system to be controlled by the transportation management device 1. The transportation machine group 2 includes at least one unmanned transportation machine 21 that operates without being driven by a human (without being manipulated by riding thereon or being remotely manipulated), such as a drone. The unmanned transportation machines 21 may include not only flying bodies such as drones, but also other transportation machines that do not necessitate a driving person (a person riding thereon or a remotely-manipulating person), such as unmanned vehicles equipped with automated driving functions. Further, the transportation machine group 2 may include one or more manned transportation machines 22 which are driven by a driving person (a person riding thereon or a remotely-manipulating person). The manned transportation machines 22 may include, for example, vehicles such as trucks, motorcycles and bicycles, and may also include aircrafts such as airplanes and helicopters, and ships.

Some or all of the manned transportation machines 22 (for examples, trucks) are equipped with monitors 23 in their driving rooms. Instead of the monitors 23, it is also possible to use, as monitors, mobile terminals 24 carried by the persons driving the manned transportation machines 22. The mobile terminals 24 may be typically smart phones and, also, may include tablet PCs, notebook PCs, cellular phones, PDAS, and the like.

Also, the mobile terminals 24 may be carried by not only the persons driving the manned transportation machines 22, but also personnel relating to the management of the transportation machine group 2, such as personnel who load and unload the cargos on and from the unmanned transportation machines 21 and the manned transportation machines 22, personnel who perform replacement and charging of batteries, refueling and other maintenances for the unmanned transportation machines 21 and the manned transportation machines 22, for example.

Each of the unmanned transportation machines 21, the manned transportation machines 22 and the mobile terminals 24 is provided with a GNSS mobile station, and the current positions of the unmanned transportation machines 21, the manned transportation machines 22 and the mobile terminals 24 are acquired by a GNSS system.

Further, the unmanned transportation machines 21, and the manned transportation machines 22 that are moved by motive power are each equipped with a computer. These computers are capable of communicating with the transportation management device 1 and transmit information about the remaining amount of a battery, the remaining amount of a fuel, the current position of the machine body, and the like to the transportation management device 1. Further, these computers receive a movement plan from the transportation management device 1. In each unmanned transportation machine 21, the computer controls the machine body for causing it to autonomously move, according to the received movement plan. In each manned transportation machine 22, the computer outputs the received movement plan to the monitor 23 for displaying the movement plan thereon. Similarly, each mobile terminal 24 outputs and displays the received movement plan.

### The Transportation Management Device

The transportation management device 1 illustrated in FIG. 1 includes a storage 11, a computer 12, and a communication device 13.

The storage 11 is constituted by, for example, a HDD and the like and stores information about a plurality of loading spots at which the unmanned transportation machines 21 and the manned transportation machines 22 are to load and unload to-be-transported objects (cargos) thereon and therefrom, and the respective positions of them. In addition, the storage 11 may store information (data) about the respective IDs, types and the like of the unmanned transportation machines 21 and the manned transportation machines 22 which belong to the transportation system.

Also, the storage 11 may store information (data) about the current positions and the current travelable distances of the respective transportation machines, which are calculated by the transportation management device 1 based on the current positions, the remaining amounts of batteries, the remaining amounts of the fuel having been received from the unmanned transportation machines 21, and the manned transportation machines 22. Although the single storage 11 is illustrated in FIG. 1, there may be a plurality of storages 11.

Further, preferably, the storage 11 may preliminarily store equipment information (the types, numbers and the like of pieces of loading/unloading equipment) about the loading/unloading equipment for the cargos, which are installed at the loading spots. The loading/unloading equipment is the equipment for unloading and loading the cargos from and on the transportation machines. The loading/unloading equipment includes apparatuses constituted by one or plural machines for loading and unloading the cargos on and from the unmanned transportation machines 21 automatically and in an unmanned manner, such as robot arms and conveyers, and, further, includes loading machines and the like which are driven or manipulated by operators, such as forklifts and cranes.

Furthermore, preferably, the storage 11 preliminarily stores information about a cargo storage state at each loading spot. The information about the cargo storage state includes information about the rate of the amount of currently-stored cargos to the storage capacity, the amount of cargos that can be currently taken in, and the like, at each loading spot.

Incidentally, the storage 11 may be assembled in the inside of a housing of the computer 12 or may be connected to the computer 12 through a terminal. Also, the storage 11 may be connected to the computer 12 through a wired or wireless network.

The computer 12 includes, for example, a processor such as a CPU, a ROM for storing various types of programs, a RAM for temporarily storing data during calculation processes, and the like, and executes software for realizing functions relating to creation of the aforementioned movement plan. The computer 12 can access the storage 11. The computer 12 selects a machine in charge as at least one transportation machine in charge of transportation of a cargo and, further, selects a loading spot at which the machine in charge is to load or unload the cargo thereon or therefrom, according to the respective transportation machines and the current positions of them, based on a dispatch spot, a dispatch time and a destination for the cargo which have been inputted through an input device such as a keyboard and a mouse or other terminals and inputted through a network. Further, the computer 12 calculates times when the machine in charge is to arrive at and depart from the loading spot and creates a movement plan for the machine in charge. Incidentally, information about the cargos, which is inputted through the input device, may further include information about the number and weights of the cargos, the sizes of the cargos, types of contents therein (fragile articles, cloths, food and the like).

Further, the computer 12 may write and store the created movement plan in the storage 11 and another storage medium 14. The storage medium 14 may be various types of storage devices, such as a semiconductor memory or an external HHD connected to the computer 12 in a wired or wireless manner, a network memory, a CD-ROM.

The communication device 13 is, for example, a wired or wireless communication device that can be connected to the Internet, the Intranet or the like. The computer 12 transmits the created movement plans for the respective transportation machines, through the communication device 13, to the corresponding unmanned transportation machines and manned transportation machines 22, or the mobile terminals 24, thereby controlling the transportation machine selected as the machine in charge. The movement plans transmitted to the unmanned transportation machines 21 serve as operation commands for the unmanned transportation machines 21, and the unmanned transportation machines 21 operate based on the movement plans. The movement plans transmitted to the manned transportation machines 22 serve as display commands for the monitors 23 in the manned transportation machines 22 or the mobile terminals 24.

The computer 12 can receive weather information 15 and traffic information 16 through a network, through the communication device 13.

### The Movement Plan

The movement plans created by the computer 12 are one type of control information about the transportation machine group 2, and are successively created for the individual unmanned transportation machines 21 and the individual manned transportation machines 22, according to their respective states. Specifically, for each transportation machine, the movement plan includes information about a loading spot (for example, an ID and a name of the loading spot, a position information about the loading spot, and the like) at which the cargos are to be loaded or unloaded, and estimated times of arrival and departure at and from the loading spot. The loading spot is a place for storing the cargos, which is preliminarily determined in an area to which the cargos are delivered by the transportation system, and is, for example, a business office, a store house or the like owned by a manager of the transportation system. In addition, in a case where the transportation machine is planed to receive or transfer a cargo from or to another transportation machine at the loading spot, the movement plan for each of the transportation machines may include information about the partner transportation machine in receiving or transferring the cargo (for example, an ID and a type of the transportation machine, estimated times of arrival and departure of the transportation machine, and the like).

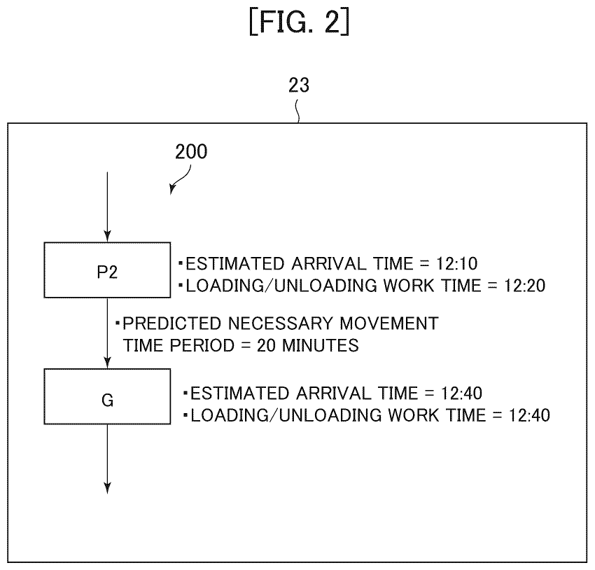

FIG. 2 is an image diagram of a movement plan transmitted to the manned transportation machine 22. In the example of FIG. 2, on the monitor 23, there is displayed, as a movement plan 200, information about a loading spot P2 where this transportation machine 22 is to load a cargo thereon, a destination spot G, an estimated time of arrival at the loading spot P2, a loading/unloading work time when the cargo is to be loaded thereon, a predicted necessary movement time period predicted as a time period taken for movement from the loading spot P2 to the destination spot, an estimated time of arrival at the destination spot G, a loading/unloading work time when the cargo is to be unloaded therefrom.

At this time, the computer 12 receives at least one of weather information 15 and traffic information 16 through the network, through the communication device 13. Further, the computer 12 determines whether or not the transportation machine selected as the machine in charge can arrive at the loading spot, or a delay time period. Thus, the computer 12 reflects the result of the determination on the aforementioned movement plan. The weather information 15 can be reflected on the creation of the movement plan, as follows. For example, in a case where a drone is obstructed from travelling due to bad weather such as strong winds or heavy rains, the drone is excluded from candidates for a machine in charge, and a vehicle such as a truck is selected as the machine in charge. For example, in a case where there are listed plural candidates for a transportation route from a dispatch spot to a destination, according to the dispatch spot and the destination for a cargo, it is possible to ascertain whether a traffic jam has occurred on a land road included in any of the candidates for the transportation route. If the occurrence of a traffic jam is ascertained, the computer 12 calculates a predicted delay time period caused by the traffic jam, further corrects an estimated necessary time period taken for transportation of the cargo for each candidate for the transportation route and, then, selects a most reasonable transportation route (which realizes a shortest transportation time period, or a lowest transportation cost, for example). In this manner, the traffic information 16 can be reflected on the creation of the movement plan.

Further, based on the aforementioned equipment information about the loading spots, which is stored in the storage 11, the computer 12 can determine whether or not loading/unloading equipment can be used for loading or unloading the cargos on or from the machine in charge at the loading/unloading spots. In this case, the computer 12 can determine that loading or unloading of the cargos on or from the machine in charge can be attained in a shorter time period and with a lower cost using the loading/unloading equipment, or that a plurality of personnel is required for loading or unloading of the cargos since the loading/unloading equipment cannot be used. In this manner, the computer 12 can reflect the equipment information on the movement plans, through comparison of the time period and cost required for loading or unloading of the cargos among the respective loading sports, and the like.

Furthermore, based on the number, weight and the like of the cargos, for example, the computer 12 can calculate the number of personnel necessary for loading or unloading the cargos at a selected loading spot, as basic information for creating the movement plan. In this case, if the number of personnel necessary for loading or unloading the cargos to be loaded or unloaded is not reached, even by additionally using the personnel at the loading spot and the personnel riding on the manned transportation machine 22 travelling toward the loading spot, the computer 12 can exclude this loading spot from candidates for selection. It is conceived that the number of necessary personnel can be calculated, for example, by preliminarily determining a weight loadable by one personnel, and dividing the weight of the cargos to be loaded by this loadable weight and rounding up the fraction. In this manner, the computer 12 creates the movement plan in consideration of the number of necessary personnel, and transmits the created movement plan to the monitor 23 in the manned transportation machine 22 selected as the machine in charge, or the mobile terminal 24 carried by a working personnel who belongs to this loading spot, for causing the monitor 23 or the mobile terminal 24 to display and output the movement plan thereon. This facilitates guidance of personnel such that a number of personnel necessary for loading or unloading the cargos, including the personnel riding on the manned transportation machine 22 and the working personnel at the loading spot, gather at the loading spot at the time of loading or unloading of the cargos.

### Creation of the Movement Plan

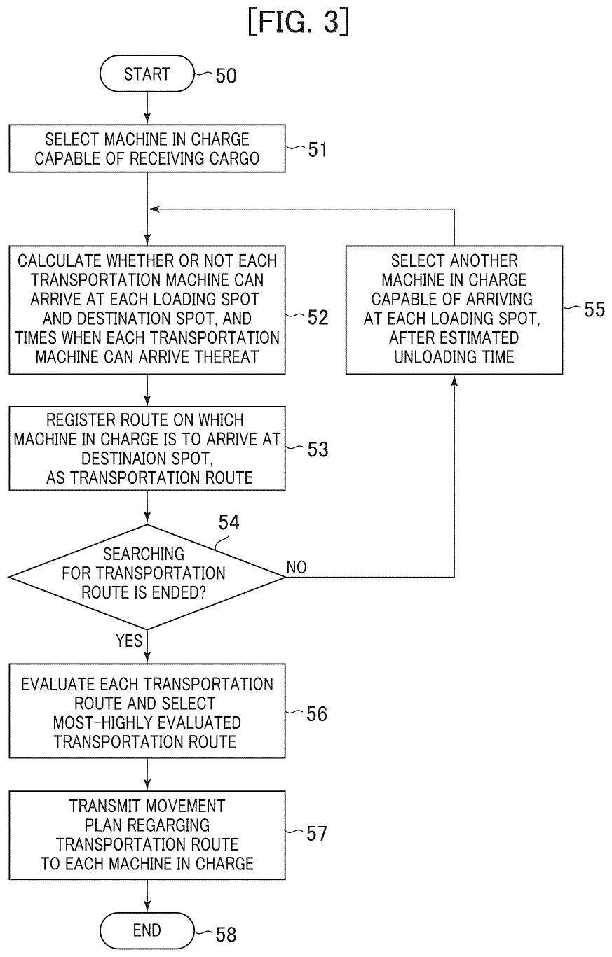

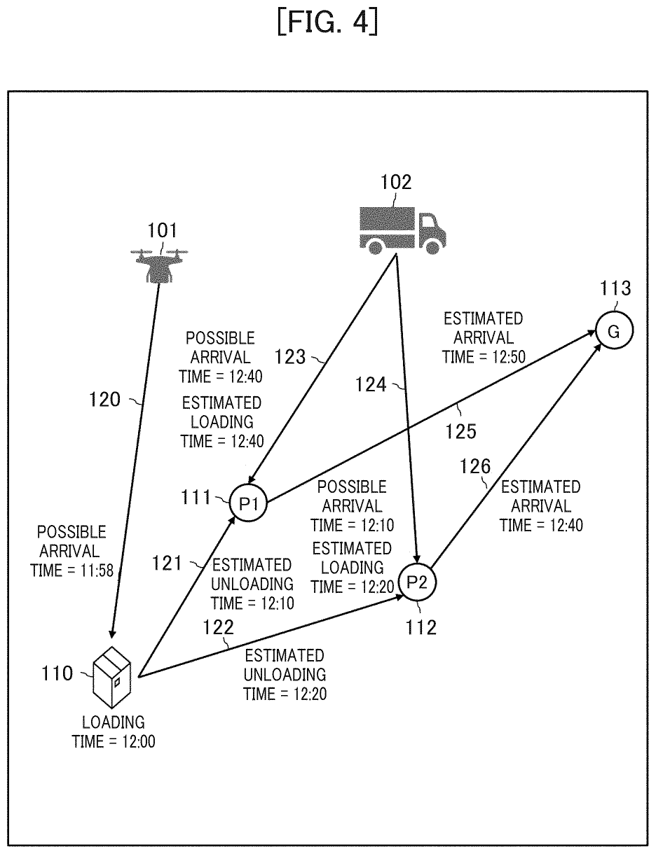

FIG. 3 is a flow chart illustrating the procedure of creating and outputting the movement plan by the transportation management device 1, and FIG. 4 is an image diagram of the creation of the movement plan.

### Processing 50

Regarding a cargo required to be transported, if information about a dispatch spot 110, a dispatch time, a destination spot 113, a cargo ID and the like is inputted to and registered in the computer 12, the computer 12 starts the flow of FIG. 3 for this cargo, in the processing 50.

### Processing 51

If the flow of FIG. 3 is started, at first, the computer 12 selects a transportation machine capable of receiving this cargo at the dispatch spot 110, in the processing 51. For example, based on the current positions of the respective transportation machines, the computer 12 extracts candidates for a transportation machine which are capable of arriving at the dispatch spot 110 before the dispatch time. At this time, the computer 12 excludes, from the candidates, a transportation machine for which a movement plan has been already created, but it is necessary to change the existing movement plan, even if the transportation machine is capable of arriving at the dispatch spot 110 before the dispatch time, based on the positional relationship between the dispatch spot 110 and the current position. The computer 12 preferentially extracts transportation machines for which no movement plan has been created, and transportation machines capable of arriving at the dispatch spot 110 before the dispatch time without necessitating a change of the existing movement plan.

In FIG. 4, there is assumed and illustrated a case where a drone 101, which is an unmanned transportation machine 21, is selected as the machine in charge, in the processing 51, since it can arrive at the dispatch spot 110 before a loading time (12:10) calculated back from the dispatch time (it can arrive at 11:58).

### Processing 52

Next, in the processing 52, the computer 12 acquires the position information about loading spots from the storage 11, and extracts at least one candidate for a loading spot as required, based on the positional relationship between the dispatch spot 110 and the destination spot 113, and information about the travelable distance and the like of the drone 101.

In FIG. 4, there is assumed and illustrated a case where two loading spots 111 and 112 are extracted in the processing 52.

Further, the computer 12 determines whether it is possible to unload the cargo at each of the loading spot 111 and the loading spot 112, based on the current receivable amount of cargos at each of the loading spot 111 and the loading spot 112, and the equipment information and the like about each of the loading spot 111 and the loading spot 112. If it is possible, the computer 12 calculates an estimated time when the drone 101 is to arrive at each of the loading spot 111 and the loading spot 112. Then, based on the calculated estimated time of arrival, the computer 12 determines an estimated unloading time at each of the loading spot 111 and the loading spot 112.

In FIG. 4, there is illustrated a case where the drone 101 can unload the cargo at each of the loading spot 111 and the loading spot 112, and the estimated unloading times at the loading spot 111 and the loading spot 112 are calculated to be 12:10 and 12:20, respectively, in the processing 52.

### Processing 53

Next, in the processing 53, the computer 12 records and registers a route for the machine in charge to arrive at the destination spot 113, as a transportation route, in the storage 11 or another storage.

In the example of FIG. 4, at first, it is determined whether the loading spot 111 or the loading spot 112 selected in the processing 52 is the destination spot 113. In a case where the loading spot 111 or the loading spot 112 is the destination spot 113, namely the cargo can be transported to the destination spot 113 by the drone 101, this route (for causing the drone 101 to unload the cargo at the destination spot 113) is registered as a transportation route in the storage 11 or another storage. In FIG. 4, neither the loading spot 111 nor the loading spot 112 is the destination spot 113, namely the cargo cannot be unloaded at the destination spot 113 by the drone 101. Therefore, at the present time point (at the time of the determination regarding the place at which the drone 101 is to arrive), no appropriate transportation route exists and is registered.

### Processing 54

Next, in the processing 54, the computer 12 determines whether to end the searching for a transportation route. If the computer 12 continues the searching, the computer 12 shifts the procedure to processing 55. If the computer 12 ends the searching, the computer 12 shifts the procedure to processing 56. An actual example of the processing 54 can be conceived as follows. That is, in a case where the number of transportation routes has reached a specified value, or in a case where the time period elapsed since the start of the flow of FIG. 3 has reached a specified time period, the searching for a transportation route is ended. In FIG. 4, no appropriate transportation route exists at the present time point (at the time of the determination regarding the place at which the drone 101 is to arrive) and, therefore, the determination in the processing 54 is not satisfied, thus, the processing 54 results in a determination of “NO”, and the procedure is shifted to the processing 55.

### Processing 55

In a case where the computer 12 determines to continue the searching for a candidate for a movement plan in the processing 54, next, the computer 12 shifts the procedure to the processing 55, thereby selecting a transportation machine (namely, another machine in charge to take over the cargo from the machine in charge which has unloaded the cargo at each of the loading spot 111 and the loading spot 112) capable of loading the cargo thereon after the estimated unloading time calculated in the processing 52 at each of the loading spot 111 and the loading spot 112. Then, the computer 12 returns the procedure to the processing 52. As an actual example of the processing 55, assuming a case where a transportation machine arrives at each of the loading spot 111 and the loading spot 112 before the corresponding estimated unloading time and waits at each of the loading spot 111 and the loading spot 112 until the estimated unloading time and loads the cargo thereon, or a case where a transportation machine arrives at each of the loading spot 111 and the loading spot 112 after the corresponding estimated unloading time and immediately loads the cargo thereon, a transportation machine available without changing the existing movement plan is selected as a machine in charge of takeover, similarly to in the selection of the drone 101 in the processing 51.

In FIG. 4, there is illustrated a case where it is calculated in the processing 55 that a truck 102, which is a manned transportation machine 22, can arrive at each of the loading spot 111 and the loading spot 112 after/before the estimated unloading time for the drone 101 and can load the cargo thereon, further, it is calculated in the processing 52 and 53 that the truck 102 can arrive at the destination spot 113 at 12:50 or 12:40, and these two transportation routes are registered. If the condition in the processing 54 is satisfied since the transportation route is registered as described above, the computer 12 makes a determination of “YES” and shifts the procedure to the processing 56.

### Processing 56

In a case where the computer 12 determines to end the searching for a transportation route in the processing 54, next, the computer 12 evaluates each transportation route and determines a movement plan based on the result of the evaluation, in the processing 56. An actual example of the processing 56 can be conceived as follows. That is, a transportation cost based on the time period for which each transportation machine is to be bound, and the distance by which each transportation machine is to move, and an efficiency cost calculated from the time period required for transportation of the cargo are calculated as evaluation items. Further, a transportation route which minimizes the sum of the transportation cost and the efficiency cost is identified as a base of the movement plan.

For example, in FIG. 4, a first transportation route passing through routes 120, 121 and 125, and a second transportation route passing through routes 120, 122 and 126 are registered. On the first transportation route, the truck 102 can arrive at the destination spot 113 later, but the truck 102 (the personnel riding thereon) spends no waiting time at the loading spot 111, as compared with on the second transportation route. On the other hand, on the second transportation route, a waiting time period occurs at the loading spot 112, but the truck 102 can arrive at the destination spot 113 earlier, as compared with on the first transportation route. Therefore, in order to consider the trade-off therebetween, it is conceived to adopt a method as follows, as a method for making a selection therefrom. That is, a function based on the time period and cost required for transportation as described above is preliminarily defined, and a transportation route as an optimum solution is selected therewith. Here, it is assumed that the second transportation route is selected.

### Processing 57

Next, in the processing 57, the computer 12 transmits, as a movement plan, information about the dispatch spot 110, the loading spot 112 and the destination spot 113 through which the respective machines in charge, namely the drone 101 and the truck 102 are to pass, and the arrival and departure times and the loading/unloading times at the respective spots, on the selected second transportation route, to the respective transportation machines (the drone 101 and the truck 102), and to the mobile terminals 24 carried by the personnel riding on the truck 102 and the personnel at the loading spot 112 and the like, as required, through the communication device 13. Further, the computer 12 ends the flow of FIG. 3, regarding the cargo received in the processing 50. At this time, the computer 12 outputs and stores the movement plan to and in the storage 11, the storage medium 14, and the like. The storage of the movement plan in the storage medium 14 can be also executed, in response to a manipulation for making a request to the computer 12.

Further, as described above, weather information 15 and traffic information 16 may be reflected on the movement plan. Further, in a case where personnel are required for loading and unloading the cargos on and from the drone 101 and the truck 102, at the dispatch spot 110, the loading spot 111, the loading spot 112 and the destination spot 113, the movement plan is displayed on the monitor 23, the mobile terminals 24 and the like, as described above, thereby securing desired personnel.

As the transmission of the movement plans to the transportation machines, it is conceived to transmit the movement plan to an unmanned transportation machine, according to a command format required generally for running the unmanned transportation machine, and to transmit the movement plan as an image, for a manned transportation machine, to the mobile terminal 24 and the monitor 23 to be viewed by the person riding on the manned transportation machine and running it.

### Effects

According to the present embodiment, it is possible to appropriately schedule transfer of the cargos between plural machines in charge, including unmanned transportation machines 21, at loading spots, which enables realization of an effective transportation system capable of causing the plural machines in charge to cooperate with each other, as required. This can improve the running efficiency of the entire transportation system including the unmanned transportation machines 21, such as the drones 101.

Further, as described above, it is possible to reflect weather information 15 and traffic information 16 about areas around the loading spots on the movement plans. For example, if a delay due to a traffic jam or the like is predicted, it is possible to calculate the estimated arrival time in such a way as to make it later by a delay time period. If a drone has difficulty in arriving at a loading spot due to strong winds, it is possible to preferentially adopt land transportation. In this manner, it is possible to reduce the risk that the movement plan is not realized due to an unpredicted delay or nondelivery. As described above, it is possible to create appropriate movement plans, including selection of machines in charge and extraction of transportation routes, flexibly according to weather and traffic conditions.

Further, it is possible to determine whether or not loading/unloading equipment can be used for loading or unloading the cargos on or from the machine in charge at each loading spot, based on the equipment information about the loading spot, and it is possible to reflect the result of the determination on the movement plan. For example, in a case where there are listed, as candidates, plural loading sports provided with different pieces of loading/unloading equipment, such as loading spots at which the cargos can be automatically loaded and unloaded on and from unmanned transportation machines 21, loading spots at which the cargos can be unloaded from unmanned transportation machines 21 but personnel are required for loading the cargos thereon, it is possible to create movement plans in consideration of such restriction of the loading/unloading equipment. This point can contribute to flexible creation of appropriate movement plans.

Furthermore, the computer 12 can calculate the number of personnel necessary for loading or unloading the cargos on or from the machine in charge, at each loading spot. In this case, if the number of personnel necessary for loading or unloading the cargos to be loaded or unloaded is not reached, even by additionally using the personnel at the loading spot and the personnel riding on the manned transportation machine 22 travelling toward the loading spot, the computer 12 can exclude this loading spot from candidates for selection. The movement plan created in consideration of the number of necessary personnel as described above is displayed on the monitor 23 in the manned transportation machine 22 selected as the machine in charge, or the mobile terminals 24 carried by working personnel at the loading spot included in the transportation route. This facilitates guidance of personnel such that a number of personnel necessary for loading or unloading the cargos, including the personnel riding on the manned transportation machine 22 and the working personnel at the loading spot, gather at the loading spot at the time of loading or unloading the cargos.

Further, it is possible to include a loading spot estimated to secure a necessary number of personnel, in the options of selection of the transportation route, even if this loading spot is not originally selected as a route since it is provided with no loading/unloading equipment for loading and unloading the cargos on and from the unmanned transportation machine 21. This can reduce the cost for the investment for the equipment at loading spots. These points also can contribute to improvement of the running efficiency of the transportation system.

Further, the movement plans are stored in the storage 11, the storage medium 14 and the like, which enables ex post facto check of the movement plans or utilization of the history for mechanical learning and the like.

### LIST OF REFERENCE SIGNS

1: transportation management device
11: storage
12: computer
14: storage medium
15: weather information
16: traffic information
21: unmanned transportation machine
22: manned transportation machine
23: monitor
24: mobile terminal
110: dispatch spot
111, 112: loading spot
113: destination spot
200: movement plan

1. A transportation management device for managing transportation of a to-be-transported object, the transportation management device including a computer for creating a movement plan for a plurality of transportation machines including at least one unmanned transportation machine, wherein
the computer can access a storage storing positions of a plurality of loading spots at which the transportation machines load and unload the to-be-transported object thereon and therefrom,
the computer selects a machine in charge as at least one transportation machine in charge of transportation of a cargo, and, further, selects a loading spot at which the machine in charge is to load or unload the cargo thereon or therefrom, according to current positions of the plurality of transportation machines, based on a dispatch spot, a dispatch time, and a destination for the cargo, which have been inputted,
the computer calculates times when the machine in charge is to arrive at and depart from the loading spot and creates the movement plan, and
the computer controls the machine in charge, based on the movement plan.

2. The transportation management device according to claim 1, wherein
the computer receives at least one of weather information and traffic information about an area around the selected loading spot and determines whether or not the machine in charge can arrive at the loading spot or a delay time period and reflects a result of the determination on the movement plan.

3. The transportation management device according to claim 1, wherein
the storage stores equipment information about loading/unloading equipment for the cargo, which is installed at the loading spots, and
the computer determines whether or not the loading/unloading equipment can be used for loading or unloading the cargo on or from the machine in charge at the loading spots, based on the equipment information, and the computer reflects a result of the determination on the movement plan.

4. The transportation management device according to claim 1, wherein
the computer calculates the number of personnel necessary for loading or unloading the cargo at the selected loading spot, and outputs the movement plan to a monitor in a manned transportation machine selected as the machine in charge, or a mobile terminal carried by a working personnel.

5. The transportation management device according to claim 1, wherein
the computer stores the movement plan in the storage or another storage medium.

6. The transportation management device according to claim 1, wherein
the unmanned transportation machine is an flying body.

7. A transportation management method for managing transportation of a to-be-transported object, by creating a movement plan for a plurality of transportation machines including at least one unmanned transportation machine, the method comprising:
preliminarily setting positions of a plurality of loading spots at which the transportation machines load and unload the to-be-transported object thereon and therefrom;
selecting a machine in charge as at least one transportation machine in charge of transportation of a cargo, and, further, selecting a loading spot at which the machine in charge is to load or unload the cargo thereon or therefrom, according to current positions of the plurality of transportation machines, based on a dispatch spot, a dispatch time, and a destination for the cargo;
calculating times when the machine in charge is to arrive at and depart from the loading spot and creating the movement plan; and
controlling the machine in charge, based on the movement plan.

8. A transportation management system for managing transportation of a to-be-transported object, the transportation management system including a plurality of flying bodies for transporting the to-be-transported object, and a computer for creating a movement plan for the plurality of flying bodies, wherein
the computer can access a storage storing positions of a plurality of loading spots at which the flying bodies load and unload the to-be-transported object thereon and therefrom,
the computer selects a machine in charge as at least one flying body in charge of transportation of a cargo, and, further, selects a loading spot at which the machine in charge is to load or unload the cargo thereon or therefrom, according to current positions of the plurality of flying bodies, based on a dispatch spot, a dispatch time, and a destination for the cargo, which have been inputted, and
the computer calculates times when the machine in charge is to arrive at and depart from the loading spot and creates the movement plan, and
the flying body operates based on the movement plan.
